(19) United States
(12) Patent Application Publication
(10) Pub. No.: US 2022/0253500 A1
(43) Pub. Date: Aug. 11, 2022

(54) QR Code Packaging System

(71) Applicant: Travell Baldwin, Henderson, NV (US)

(72) Inventor: Travell Baldwin, Henderson, NV (US)

(21) Appl. No.: 17/665,822

(22) Filed: Feb. 7, 2022

Related U.S. Application Data
(60) Provisional application No. 63/147,372, filed on Feb. 9, 2021.

(51) Int. Cl. G06F 16/955; G06K 19/06; G06K 19/077; G06K 7/14; G06K 1/12

(52) U.S. Cl. CPC G06F 16/9554; G06K 19/06009; G06K 1/121; G06K 7/1417; G06K 19/0776

(57) ABSTRACT

The present invention relates to a QR code packaging system comprised of at least one piece of packaging, at least one QR code or other unique, scannable code attached to the packaging and at least one method of use. In the preferred embodiment, the packaging is a small, zip-closure plastic bag used in cannabis dispensaries. The QR code is further attached to or placed within the packaging. When scanned, the QR code redirects the user to a secondary digital location on a smart device that was used to scan the QR code. Said location may be, but is not limited to, a social media page, a music page, a website, etc.

### CROSS-REFERENCE TO RELATED APPLICATION

The present application claims priority to, and the benefit of, U.S. Provisional Application No. 63/147,372, which was filed on Feb. 9, 2021 and is incorporated herein by reference in its entirety.

### FIELD OF THE INVENTION

The present invention relates generally to the field of packaging. More specifically, the present invention relates to a QR code packaging system comprised of at least one piece of packaging, at least one QR code (or other unique, scannable code) attached to the packaging, and at least one method of use. In the preferred embodiment, the packaging is a small, zip-closure plastic bag used in cannabis dispensaries. The QR code is further attached to or placed within the packaging. When scanned, the QR code redirects the user to a secondary digital location on a smart device that was used to scan the QR code. Accordingly, the present disclosure makes specific reference thereto. Nonetheless, it is to be appreciated that aspects of the present invention are also equally applicable to other like applications, devices and methods of manufacture.

### BACKGROUND

Many types of goods are sold in small, plain packages. One type of business that uses said packaging is cannabis dispensaries, who often sell small amounts of cannabis in small, plain packages. On said packages, there may be a lack of advertisements and designs due to the small size and economic and practical feasibility of printing advertisements and designs onto the small packaging. Further, many popular celebrities or artists have their own cannabis strains, but a purchaser of said strain may have no knowledge of the celebrity or artist whose strain it is.

Therefore, there exists a long-felt need in the art for an improved packaging system that can be used in a business such as, but not limited to, cannabis selling and distributing. There also exists a long-felt need in the art for a QR code packaging system that allows for advertisements on small, plain packages that are used to distribute cannabis at cannabis dispensaries. Further, there exists a long-felt need in the art for a QR code packaging system comprised of a small, plain package that is used to distribute cannabis at cannabis dispensaries, wherein the system allows a purchaser of said cannabis to become aware of the celebrity, artist, creator, owner, etc., of the cannabis strand they have purchased.

The subject matter disclosed and claimed herein, in one embodiment thereof, comprises a QR code packaging system. The system is comprised of at least one piece of packaging, at least one QR code (or other unique, scannable code) attached to the packaging, and at least one method of use. In the preferred embodiment, the packaging is a small, zip-closure plastic bag used in cannabis dispensaries. The QR code is further attached to or placed within the packaging. When scanned, the QR code redirects the user to a secondary digital location on a smart device that was used to scan the QR code. Said location may be, but is not limited to, a social media page, a music page, a website, etc. Further, said secondary location may relate to an individual, group, or company that created, owns, endorses, distributes, processes, or licenses, etc., the cannabis strain stored within the packaging that the QR code is located on.

In this manner, the QR code packaging system of the present invention accomplishes all of the forgoing objectives, and provides a QR code packaging system that allows advertisements to be integrated on small, plain packages that are used to distribute cannabis at cannabis dispensaries. Further, the system allows a purchaser of said cannabis to become aware of the celebrity, artist, creator, owner, etc., of the cannabis strand they have purchased. As a result, the system overcomes the limitations of existing packaging in the cannabis industry, and other industries known in the art with similar packaging.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a QR code packaging system. The system is comprised of at least one piece of packaging, at least one QR code attached to the packaging and at least one method of use. In differing embodiments, the system can be used with any suitable packaging as is known in the art. Although in the preferred embodiment, the system is used on cannabis packaging and the packaging is in the form of a small, zip-closure plastic bag. In differing embodiments, the size and material of the packaging may vary to accommodate differing quantities and weights of cannabis or any other suitable product as is known in the art.

The outer surface of the packaging is further comprised of at least one QR code or any suitable unique, scannable code as is known in the art. In various embodiments, the QR code may be an adhesive sticker that can be pressed onto the outer surface of the packaging, can be embossed, printed, or overlayed over the outer surface of the packaging, etc., or may be in the form of a paper-based card that is stored within the packaging and can be removed when the cannabis is also removed from the packaging. The QR code can be then scanned using the camera of a smart device, such that after being scanned, the QR code redirects the operating system of the smart device to a secondary digital location.

In one embodiment, the secondary digital location may be a social media page of a relevant individual or group of persons related to the cannabis strain stored within the packaging that the QR code is located on. Said individual/group may include, but is not limited to, an individual, a group, a team, a celebrity, an artist, a pop-culture figure, a company, an organization, a business, a fictional character, a brand, etc., that created, owns, endorses, distributes, or licenses, etc., the cannabis strain stored within the packaging that the QR code is located on.

In a differing embodiment, the secondary digital location may be a music-related page, such as a music-playing mobile application page or a music website of a relevant individual or group of persons related to the cannabis strain stored within the packaging that the QR code is located on. Said individual/group may include, but is not limited to, an individual, a group, a team, a celebrity, an artist, a pop-culture figure, a company, an organization, a business, a fictional character, a brand, etc., that created, owns, endorses, distributes, or licenses, etc., the cannabis strain stored within the packaging that the QR code is located on.

In a further embodiment, the secondary digital location may be a website. Said website may be a consumer website that allows users a chance to purchase a product sold by the individual, group of persons or company related to the cannabis strain stored within the packaging that the QR code is located on. Said individual/group/company may include, but is not limited to, an individual, a group, a team, a celebrity, an artist, a pop-culture figure, a company, an organization, a business, a fictional character, a brand, etc., that created, owns, endorses, distributes, or licenses, etc., the cannabis strain stored within the packaging that the QR code is located on.

In an additional embodiment, the secondary digital location may be a website of a dispensary or cannabis manufacturer, processor, distributor, etc. Said website may be the website of an individual, group, company or dispensary that creates, sells, processes, or distributes the cannabis strain stored within the packaging that the QR code is located on.

In an additional embodiment, a method of using the system is disclosed. First, at least one QR code is secured onto at least one piece of packaging. Then, the packaging is filled with a product, such as, but not limited to, cannabis, and then sold to or observed by a user. The user then uses a camera of a smart device to scan the QR code on the packaging. The QR code then redirects the operating system of the smart device to a secondary digital location, wherein said digital location may include, but is not limited to, any suitable type of secondary digital location disclosed supra. The user can then view or engage with the content on the secondary digital location.

Accordingly, the QR code packaging system of the present invention is particularly advantageous as it provides a system that allows advertisements to be integrated on small, plain packages that are used to distribute cannabis at cannabis dispensaries, or other suitable packages as are known in the art. Further, the system allows a purchaser of said cannabis to become aware of the celebrity, artist, creator, owner, etc., of the cannabis strand they have purchased. In this manner, the QR code packaging system overcomes the limitations of existing cannabis packaging and other suitable packaging as is known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the packaging and the QR code of a QR code packaging system of the present invention in accordance with the disclosed architecture;

FIG. 2 illustrates a graphical view of one potential embodiment of the QR code packaging system of the present invention in accordance with the disclosed architecture; and

FIG. 3 illustrates a flow chart of one potential method of using the QR code packaging system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved packaging system that can be used in a business such as, but not limited to, cannabis selling and distributing. There also exists a long-felt need in the art for a QR code packaging system that allows for advertisements on small, plain packages that are used to distribute cannabis at cannabis dispensaries. Further, there exists a long-felt need in the art for a QR code packaging system comprised of a small, plain package that is used to distribute cannabis at cannabis dispensaries, wherein the system allows a purchaser of said cannabis to become aware of the celebrity, artist, creator, owner, etc., of the cannabis strand they have purchased.

The present invention, in one exemplary embodiment, is comprised of a QR code packaging system. The system is comprised of at least one piece of packaging, at least one QR code (or other unique, scannable code) attached to the packaging and at least one method of use. In the preferred embodiment of the system, the packaging is a small, zip-closure plastic bag used in cannabis dispensaries, but can be any suitable packaging as is known in the art. The QR code is further attached to or placed within the packaging. When scanned, the QR code redirects the user to a secondary digital location on a smart device that was used to scan the QR code. Said location may be, but is not limited to, a social media page, a music page, a website, etc. Further, said secondary location may relate to an individual, group, or company that created, owns, endorses, distributes, processes or licenses the cannabis strain stored within the packaging that the QR code is located on.

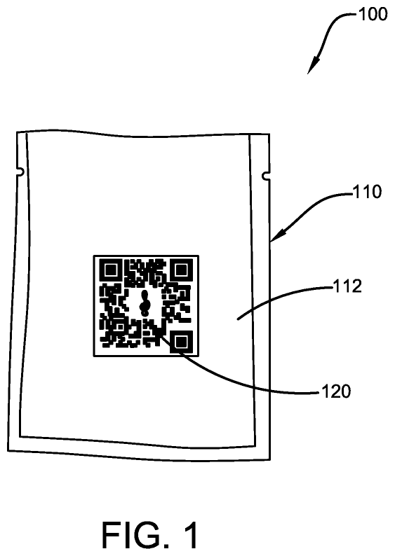

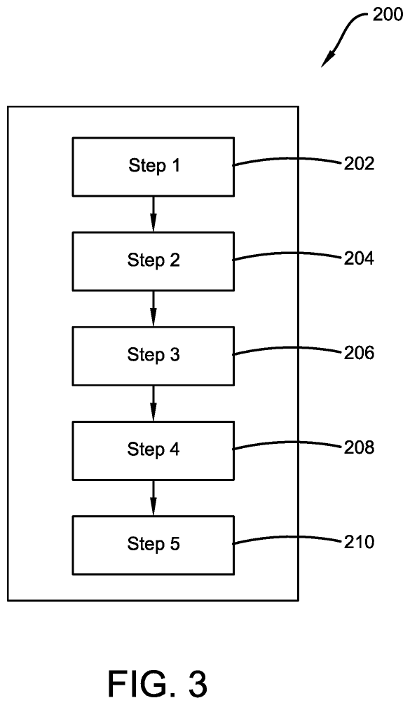

Referring initially to the drawings, FIG. 1 illustrates a perspective view of one potential embodiment of the QR code packaging system 100 of the present invention. The system 100 is comprised of at least one piece of packaging 110, at least one QR code 120 attached to the packaging 110, and at least one method of use 200 (shown in FIG. 3). In differing embodiments, the system 100 can be used with any suitable packaging 110 as is known in the art, such as cardboard, plastic bags, vacuum-formed trays, etc. Although in the preferred embodiment, the system 100 is used on cannabis packaging 110. Further, the system 100 and concept of the system 100 can be applied to any suitable packaging 110 type as is known in the art for any industry, such as, but not limited to, food, apparel, consumer products, medicine, etc. In the preferred embodiment, the packaging 110 is in the form of a small, zip-closure, plastic bag. The packaging 110 may be manufactured from any suitable natural material as is known in the art, or a plastic material such as, but not limited to, acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, recycled plastic, biodegradable plastic, etc. In differing embodiments, the size and material of the packaging 110 may vary to accommodate differing quantities and weights of cannabis or any other suitable product as is known in the art.

The outer surface 112 of the packaging is further comprised of at least one QR code 120. However, in another embodiment, the QR code 120 may in fact be any suitable unique, scannable code as is known in the art, such as an RF code, barcode, etc. In one embodiment, the QR code 120 is in the form of an adhesive sticker that can be pressed onto the outer surface 112 of the packaging 110. In another embodiment, the QR code 120 is embossed, printed, or overlayed over the outer surface 112, etc. In a further embodiment, the QR code 120 may be in the form of a paper-based card that is stored within the packaging 110 and can be removed when the cannabis is also removed from the packaging 110. In various embodiments, the QR code 120 can be scanned using the camera of a smart device, such as, but not limited to a smart phone, smart watch, or a tablet, etc., or any other suitable smart device as is known in the art.

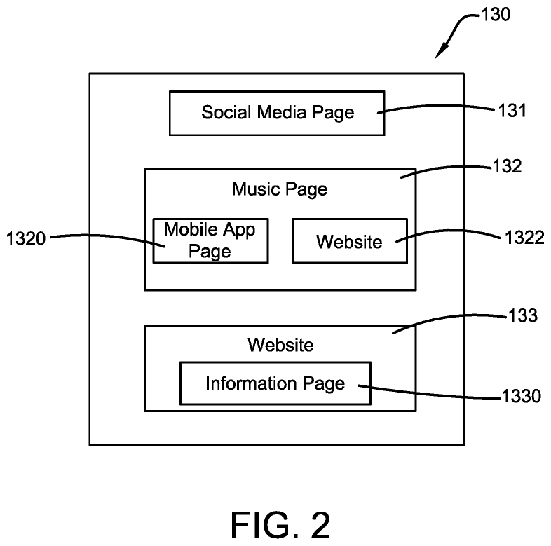

FIG. 2 illustrates a graphical view of one potential embodiment of the QR code packaging system 100 of the present invention. Once scanned by the camera of a smart device, the QR code 120 redirects the operating system of the smart device to a secondary digital location 130. In various embodiments of the system 100, the secondary digital location 130 may vary. In one embodiment, the secondary digital location 130 may be a social media page 131. Said social media page 131 may be the social media page 131 of a relevant individual or group of persons related to the cannabis strain stored within the packaging 110 that the QR code 120 is located on. Said individual/group may include, but is not limited to, an individual, a group, a team, a celebrity, an artist, a pop-culture figure, a company, an organization, a business, a fictional character, a brand, etc., that created, owns, endorses, distributes, or licenses, etc., the cannabis strain stored within the packaging 110 that the QR code 120 is located on.

In another embodiment, the secondary digital location 130 may be a music-related page 132. Said music page 132 may be a music-playing mobile application page 1320 or a music website 1322 of a relevant individual or group of persons related to the cannabis strain stored within the packaging 110 that the QR code 120 is located on. Said individual/group may include, but is not limited to, an individual, a group, a team, a celebrity, an artist, a pop-culture figure, a company, an organization, a business, a fictional character, a brand, etc., that created, owns, endorses, distributes, or licenses, etc., the cannabis strain stored within the packaging 110 that the QR code 120 is located on. In this manner, scanning the QR code 120 allows a user to view and play the music of said individual/group. The music page 132 may further be limited to a specific album, song, playlist, radio station, etc., or the entire discography of the individual/group. The music page 132 may also be related to a specific genre of music, or at least one music playlist, or any other suitable music information as is known in the art.

In a further embodiment, the secondary digital location 130 may be a website 133. Said website 133 may be a consumer website that allows users a chance to purchase a product sold by the individual, group of persons or company related to the cannabis strain stored within the packaging 110 that the QR code 120 is located on. Said individual, group, or company, etc., may include, but is not limited to, an individual, a group, a team, a celebrity, an artist, a pop-culture figure, a company, an organization, a business, a fictional character, a brand, etc., that created, owns, endorses, distributes, or licenses, etc., the cannabis strain stored within the packaging 110 that the QR code 120 is located on. In this manner, scanning the QR code 120 allows a user to view the primary website 133 of the individual, group or company, etc., such that the user may browse and potentially purchase other products that are available for sale by the individual, group, or company, etc., related to the cannabis strain stored within the packaging 110 that the QR code 120 is located on. In addition, in one embodiment, the website 133 may simply be the personal website of said individual, group, or company, etc., and does not necessarily have to offer any items for sale nor relate to the cannabis strain stored within the packaging 110 that the QR code 120 is located on.

In another embodiment, the secondary digital location 130 may be a website 133 of a dispensary or cannabis manufacturer, processor, or distributor, etc. Said website 133 may be the website of an individual, group, company, business, or dispensary, etc., that creates, sells, processes or distributes, etc., the cannabis strain stored within the packaging 110 that the QR code 120 is located on. In this manner, scanning the QR code 120 allows a user to view the website 133 of the dispensary or cannabis manufacturer, processor, or distributor, etc. In the preferred embodiment, the portion of the website 133 that the QR code 120 redirects to is an informational page 1330 relating to the specific strain of cannabis within the packaging 110 that the QR code 120 is located on, wherein the informational page 1330 provides details about the properties of the cannabis strain.

FIG. 3 illustrates a flow chart of one potential method 200 of using the QR code packaging system 100 of the present invention. First at 202, at least one QR code 120 is secured onto at least one piece of packaging 110. Then at 204, the packaging 110 can be filled with a product such as, but not limited to, cannabis, and then sold to or observed by a user. At 206, the user then uses a camera of a smart device to scan the QR code 120 on the packaging 110. At 208, the QR code 120 then redirects the operating system of the smart device to a secondary digital location 130, wherein said digital location 130 may include, but is not limited to, any suitable type of secondary digital location 130 mentioned supra. Finally, at 210 the user can then view or engage with a plurality of content on the secondary digital location.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “QR code packaging system” and “system” are interchangeable and refer to the QR code packaging system 100 of the present invention.

Notwithstanding the forgoing, the QR code packaging system 100 of the present invention and its various components can be of any suitable size and configuration as is known in the art without affecting the overall concept of the invention, provided that they accomplish the above-stated objectives. One of ordinary skill in the art will appreciate that the size, configuration and material of the QR code packaging system 100 as shown in FIGS. 1-3 is for illustrative purposes only, and that many other sizes and shapes of the QR code packaging system 100 are well within the scope of the present disclosure. Although the dimensions of the QR code packaging system 100 are important design parameters for user convenience, the QR code packaging system 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A QR code packaging system comprising:
at least one piece of packaging; and
at least one QR code positioned on or in the at least one piece of packaging, wherein once the at least one QR code is scanned by a smart device, the at least one QR code redirects an operating system of the smart device to a secondary digital location.

2. The QR code packaging system of claim 1, wherein the at least one QR code is an adhesive sticker that can be pressed onto an outer surface of the at least one piece of packaging.

3. The QR code packaging system of claim 1, wherein the at least one QR code is embossed, printed or overlayed onto an outer surface of the at least one piece of packaging.

4. The QR code packaging system of claim 1, wherein the at least one QR code is a paper-based card that is stored within the at least one piece of packaging.

5. The QR code packaging system of claim 1, wherein the secondary digital location is a social media page of a relevant individual or a group of persons related to a cannabis strain stored within the at least one piece of packaging that the at least one QR code is positioned on, and further wherein the relevant individual or group of persons comprise at least one of: an individual, a group, a team, a celebrity, an artist, a pop-culture figure, a company, an organization, a business, a fictional character, or a brand that created, owns, endorses, distributes, or licenses the cannabis strain.

6. The QR code packaging system of claim 1, wherein the secondary digital location is a music-related page of a relevant individual or a group of persons related to a cannabis strain stored within the at least one piece of packaging that the at least one QR code is positioned on, and further wherein the relevant individual or group of persons comprise at least one of: an individual, a group, a team, a celebrity, an artist, a pop-culture figure, a company, an organization, a business, a fictional character, or a brand that created, owns, endorses, distributes, or licenses the cannabis strain.

7. The QR code packaging system of claim 6, wherein the music-related page is a music-playing mobile application page, a music website, an album, a song, at least one playlist, a radio station, or a genre of music.

8. The QR code packaging system of claim 1, wherein the secondary digital location is a website of a relevant individual, a group of persons, or a company related to a cannabis strain stored within the at least one piece of packaging that the at least one QR code is positioned on, and further wherein the relevant individual or group of persons comprise at least one of: an individual, a group, a team, a celebrity, an artist, a pop-culture figure, a company, an organization, a business, a fictional character, or a brand that created, owns, endorses, distributes, or licenses the cannabis strain.

9. The QR code packaging system of claim 1, wherein the secondary digital location is a website of an individual, a group, a company, a business, or a dispensary that created, sold, processes, or distributes a cannabis strain stored within the at least one piece of packaging that the at least one QR code is positioned on.

10. The QR code packaging system of claim 9, wherein the website is an informational page that relates to the cannabis strain.

11. A QR code packaging system comprising:
at least one piece of packaging, wherein the at least one piece of packaging is a zip-closure plastic bag; and
at least one QR code positioned on or in the at least one piece of packaging, wherein once scanned by a smart device, the at least one QR code redirects an operating system of the smart device to a secondary digital location.

12. The QR code packaging system of claim 11, wherein the at least one QR code is an adhesive sticker that can be pressed onto an outer surface of the at least one piece of packaging.

13. The QR code packaging system of claim 11, wherein the at least one QR code is embossed, printed, or overlayed onto an outer surface of the at least one piece of packaging.

14. The QR code packaging system of claim 11, wherein the at least one QR code is a paper-based card that is stored within the at least one piece of packaging.

15. The QR code packaging system of claim 11, wherein the secondary digital location is a social media page of a relevant individual or a group of persons related to a cannabis strain stored within the at least one piece of packaging that the at least one QR code is positioned on, and further wherein the relevant individual or group of persons comprises at least one of: an individual, a group, a team, a celebrity, an artist, a pop-culture figure, a company, an organization, a business, a fictional character, or a brand that created, owns, endorses, distributes, or licenses the cannabis strain.

16. The QR code packaging system of claim 11, wherein the secondary digital location is a music-related page of a relevant individual or a group of persons related to a cannabis strain stored within the at least one piece of packaging that the at least one QR code is positioned on, and further wherein the relevant individual or group of persons comprises at least one of: an individual, a group, a team, a celebrity, an artist, a pop-culture figure, a company, an organization, a business, a fictional character, or a brand that created, owns, endorses, distributes, or licenses the cannabis strain.

17. The QR code packaging system of claim 16, wherein the music-related page is a music-playing mobile application page, a music website, an album, a song, at least one playlist, a radio station, or a genre of music.

18. The QR code packaging system of claim 11, wherein the secondary digital location is a website of a relevant individual, a group of persons, or a company related to a cannabis strain stored within the at least one piece of packaging that the at least one QR code is positioned on, and further wherein the relevant individual or group of persons comprises at least one of: an individual, a group, a team, a celebrity, an artist, a pop-culture figure, a company, an organization, a business, a fictional character, or a brand that created, owns, endorses, distributes, or licenses the cannabis strain.

19. The QR code packaging system of claim 11, wherein the secondary digital location is a website of an individual, a group, a company, a business, or a dispensary that created, sold, processes, or distributes a cannabis strain stored within the at least one piece of packaging that the at least one QR code is positioned on.

20. A method of using a QR code packaging system, the method comprising the steps of:
securing at least one QR code onto at least one piece of packaging;
filling the at least one piece of packaging with a product which is then sold to or observed by a user;
scanning the at least one QR code using a smart device;
redirecting an operating system of the smart device to a secondary digital location; and
viewing a plurality of content on the secondary digital location.
